(19) United States
(12) Patent Application Publication
(10) Pub. No.: US 2011/0197136 A1
(43) Pub. Date: Aug. 11, 2011

(54) WEB BROWSER INSTANCE PROFILING

(75) Inventor: Jason Duke, Hainault (GB)

(73) Assignee: StrangeLogic Limited

(21) Appl. No.: 12/703,346

(22) Filed: Feb. 10, 2010

(51) Int. Cl. G06F 3/048; G06F 17/30

(52) U.S. Cl. 715/738; 707/769; 715/762

(57) ABSTRACT

A method of profiling a web browser instance associated with a computer, so as to determine the propensity of a user of the web browser instance to undertake certain actions, the method comprising the steps of: storing a web page on a web server, said web page including profiling code; uploading the web page to a visitor web browser instance responsive to a request from said web browser; and executing the profiling code on the web server and/or web browser to extract profiling data from the visitor web browser instance. Executing the profiling code includes initiating a series of queries of the visitor web browser instance, the queries including at least one of the following techniques: determining whether a specific URL (26, 28) has previously been accessed by the web browser instance and/or determining whether a specific piece of content (36) exists within the cache of the web browser instance; and/or determining whether a user of the visitor web browser has installed a specific software application on said computer. Typically, the series of queries involves a combination of the techniques. Also, it is preferred (though not essential) for the queries to be grouped in a database (22, 34, 42) and (although preferred but not essential) for the groups of queries to be dynamically allocated, dependent on the responses to the preceding queries.

### FIELD OF THE INVENTION

The present invention concerns methods of profiling a web browser instance and/or associated computer program products and/or web servers.

### BACKGROUND OF THE INVENTION

The World Wide Web means that detailed communication between a web server and web browser are required. Much of this communication is personalised to an individual web browser; whether the site being visited is focused on news, retail, banking or some other function.

It is the ability to uniquely identify the web browser that relates to that data which enables a personalised World Wide Web experience.

One known technique for identifying and then delivering personalised functionality is via the use of cookie files. A ‘cookie’ is a small piece of text stored on a user's computer by a web browser and contains bits and bytes of information such as user preferences, shopping cart contents, an identifier for a server-based session, or other data used by websites. Hence, a unique identifier or other information can be included within one or more cookie files. A cookie can therefore be used for authenticating, session tracking (state maintenance), and remembering specific information about users, such as website preferences or the contents of their electronic shopping carts.

“First-Party Cookies” are cookies that are set by the same host-name and/or host-name sub-set as that in which the web browser is visiting.

“Third-Party Cookies” are cookies that are set by a widget or other insert coming from a host-name and/or host-name sub-set different to that in which the web browser is visiting.

The “Same-Origin Policy” is similar to First-Party Cookies and Third Party Cookies and is an important concept in various browser-side programming languages, including but not limited to Javascript. The Same-Origin Policy permits scripts running on pages originating from the same host-name and/or host-name sub-set to access each other's methods and properties with no specific restrictions. When the host-name and/or host-name sub-set are not the same, then access will be prevented. (First-Party Cookies and Third-Party Cookies and Same-Origin Policy collectively and singularly referred to as “SOP”).

Given that a cookie is sent and received as an HTTP header by web servers and/or web browsers, the SOP becomes of particularly significance in web applications as by way of example, they rely extensively on cookies to maintain authenticated user sessions, as well as web servers carry out actions based on the cookie information to reveal information and/or to take state-changing actions.

Being simple pieces of text, cookies are not executable. Most modern browsers allow users to decide whether to accept cookies, and the time frame to keep them, but rejecting cookies makes some websites unusable. For example, shopping carts or login systems implemented using cookies do not work if cookies are disabled.

Some alternatives to cookies exist; each has its own uses, advantages, and drawbacks.

Other methods of storing information that is able to be communicated between a web browser and web server are Local Stored Objects (“LSO”s), via the use of Adobe's Flash plugin for web browsers. An LSO is a collection of cookie-like data stored as a file on a user's computer. LSOs can be used by websites to collect information on how people navigate those websites and/or other information. More than half of the internet's top websites use LSOs to track users and store information about them.

Another method will be enabled when HTML5 is implemented across various browsers, see: http://www.w3.org/TR/webstorage/

All of these above methods of identification and data storage require extra data to be physically added and located on the web browsing user's computer.

The present invention overcomes these problems by enabling information, specifically a unique identification mechanism, to be communicated between a web server and a web browser, thus providing personalised web browsing functionality. This is achieved without storing a unique identifier or other extra information within the web browser's computer in the normal means. The functionality is provided independently of any data being added to the user's computer via cookies, LSOs or any other means. It is a ‘naked’ system that negates the requirement for data and/or unique identifiers of the web browser to be stored on the computer operating the web browser.

Not having to write to the web browser's cookie files (or other local) file system delivers greater efficiency for the website visitor, reducing cookie file use, hard drive space usage and CPU cycles used to write the cookie file. This offers greater functionality for website operators, since in prior systems cookies or the like are often blocked by third party applications, unwitting users of websites, ISPs or other parties. This may mean that the full functionality of being able to uniquely identify the web browser instance can confer is unable to be delivered. This reduces the quality of the experience for the visitor and/or limiting commercial opportunities for the website.

Of course, a website that operates the inventive method will indirectly benefit from the improved user experience, because users will be more prone to use and return to the website. Beyond the improved user experience, there are significant advantages to website operators in using the inventive profiling method. More directly, the operators of the website will benefit by being able to tailor the appearance and operation of the website to the particular user identified by the inventive method. Specific examples will be described in detail below.

### SUMMARY OF THE INVENTION

According to a first aspect of the invention, there is provided a method of profiling a web browser instance associated with a computer, comprising the steps of:

storing a web page on a web server, said web page including profiling code;

uploading the web page to a visitor web browser instance responsive to a request from said web browser; and

executing the profiling code on the web server to extract profiling data from the visitor web browser instance;

wherein executing the profiling code includes initiating a series of queries of the visitor web browser instance, the queries including at least one of:

determining whether a specific URL has previously been accessed by the web browser instance;

determining whether a specific piece of content exists within the cache of the web browser instance; and

determining whether a user of the visitor web browser has installed a specific software application on said computer.

By executing the profiling code on the web server, the computer user is blind to the operation and thus cannot override it unless they have previously, or subsequently go on to change their web browser settings. In fact, even altering the web browser settings will only affect some of the functionality of the inventive technique. Thus, the user is able to benefit from an enhanced web browsing experience owing to the fact that the web page may be tailored to the profile determined of the web browser instance.

Although any single query could be used, it is preferable, that a series of queries including a combination of two or more of the following be used:

determining whether a specific URL has previously been accessed by the web browser instance;

determining whether a specific piece of content exists within the cache of the web browser instance; and

determining whether a user of the visitor web browser has installed a specific software application on said computer.

Each query may have either a valid or an invalid response.

Each query may be stored in a database. The queries may be grouped within the database. When the queries are so grouped, the method may carry out furthers steps, including by way of example only and without limitation, a step of identifying the IP address of the visitor web browser instance, wherein said series of queries is determined dependent on the IP address. Alternatively, said series of queries may be determined by dynamic allocation of said grouped queries, a group of queries being asked dependent on the answers to preceding queries.

Determining whether a specific URL has previously been accessed may comprise, where the web browser instance utilises cascading style sheets (“CSS”), determining whether the style associated with that URL in the web browser is indicative of previous access.

Determining whether a specific piece of content exists within the cache of the web browser instance may comprise determining whether the load speed of said piece of content is below a predetermined threshold indicative of said piece of content being stored in the cache.

Determining whether a user of the visitor web browser has installed a specific piece of software on said computer may comprise, where the web browser is Microsoft™ Internet Explorer™ (“IE”), utilising the resource protocol to extract resources from said computer indicative of said specific piece of software being installed thereon.

The method may further comprise a step of building a profile of the web browser instance on the basis of the combination of answers to the series of queries. The combination of answers may build to a profile that is a unique identifier of a user profile under which the web browser operates. The profile may include the propensity of the user of the web browser instance to carry out a specified action.

Where each query is stored in a database, the method may further comprise the steps of:

compiling a list of specific URLs;

compiling a list of specific pieces of content;

compiling a list of specific software applications; and

creating said database of queries on the basis of said compiled lists.

According to a second aspect of the invention, there is provided a computer program product comprising profiling code uploadable to a web server and/or web browser and executable on the web server and/or web browser to extract profiling data from a visitor web browser instance, wherein said profiling code includes means to initiate a series of queries of the visitor web browser instance, the queries including at least one of:

determining whether a specific URL has previously been accessed by the web browser instance;

determining whether a specific piece of content exists within the cache of the web browser instance; and

determining whether a user of the visitor web browser has installed a specific piece of software on said computer.

According to a third aspect of the invention, there is provided a web server having computer instructions for executing the steps of:

storing a web page on a web server, said web page including profiling code;

uploading the web page to a visitor web browser instance responsive to a request from said web browser; and

executing the profiling code on the web server and/or web browser to extract profiling data from the visitor web browser instance;

wherein said executing the profiling code includes initiating a series of queries of the visitor web browser instance to uniquely identify a user profile under which the web browser operates.

### BRIEF DESCRIPTION OF THE DRAWINGS

The invention will be described, by way of example, with reference to the accompanying drawings, in which:

FIG. 1 illustrates a schematic query structure;

FIG. 2 illustrates a schematic image of a web page that is having embedded links tested using the ‘CSS Technique’ of the invention;

FIG. 3 illustrates a schematic image of a web page that is having content tested using the ‘Cache Technique’ of the invention; and

FIG. 4 illustrates a schematic image of a web page that is having content tested using the ‘Local File Technique’ of the invention.

### DESCRIPTION OF PREFERRED EMBODIMENT

Since a single computer may be used at different times by different users, or by different identities of a single user, the present invention does not strictly identify a single user or a single computer. Rather, a web browser instance is identified. As an example, a user might set up different profiles within their own computer in order to carry out distinct operations, such as one profile for general web browsing, another for web shopping and yet another profile for more private activities. Each profile could be optimised for the specific activities undertaken under that identity. Alternatively in a family group (or other situation in which a particular computer may be shared by more than one user) a profile may be set up for each member of that group. Conversely, different people, such as different members of a family group, might all log-in using the same profile.

A single log-in identity or profile will be associated with any given web browsing instance. It is the identifying data associated with that log-in identity that is queried in order to determine a profile for that log-in identity. In other words, it is the web browser instance (i.e. the log-in identity of the given web browser session) that is identified and profiled.

As used herein “web-browser” shall mean any application which as its purpose or effect is utilised to render content, whether or not said content be located locally, remotely, on the Internet, intranet, or otherwise, and includes, in particular, an http browser.

As used herein “computer” is intended to cover any device that is capable of making use of a web-browser including by way of example only, but not limited to: home computers; portable computers; web-enabled gaming devices, home entertainment systems, IPTV, fixed-line and/or mobile phones; and other similar devices.

A computer program product includes but is not limited to any appropriate computer-readable storage medium on which a computer program is stored, including, for example: magnetic or optical disks such as floppy disks, CD-ROMs or DVDs; read only memories (ROMs); random access memories (RAMs); flash memories; EPROMS; EEPROMs; or the like, as well as computer-readable instructions as carried by a signal.

With reference to the accompanying drawings, the following description sets out in detail an inventive method and associated computer program product and web server for profiling a web browser instance.

It is well known that demographic information can be beneficial for targeting marketing resources. It is also well known to assign people to a particular demographic on the basis of a series of queries (e.g. conventional questionnaire responses). For instance, a person's gender, age, level of education, income, political tendency, job description, residency, etc. are indicative of their tendency to undertake certain actions (such as buying a particular product). A person's prior purchases are also indicative of their likelihood to purchase a particular product in the future.

By extension, it is also known that a person's web browsing history can be indicative of both their demographic and their propensity to undertake certain actions.

The present invention, rather than directly looking at the history of a web browser instance, relies on secondary indications which are tested to determine whether a web browser instance is a user and/or visitor of a specific application and/or website (whether web based or locally installed).

By combining existing, yet unusual, ways of using differing standards, protocols and undocumented features within web browsers, a method of identifying a web browser instance that is unique to the user profile under which the web browser operates has been produced.

An application embodying the present invention and including profiling code is installed on a particular website. Every web browser that visits a page within that website on which the application has been installed has multiple tests run on the browser by the profiling code. Each test (or query) returns either a valid or invalid response. By combining the results of the queries, it is possible to ascertain the web browser instance uniquely.

Moreover, depending on the responses to those queries, it is possible to ‘funnel’ towards further queries, leading to a unique set of questions that will uniquely identify that particular web browser instance.

At least three different techniques (lines of enquiry) are possible. Although any single technique could provide a unique identification, preferably, two or more of these techniques are combined.

### CSS Technique:

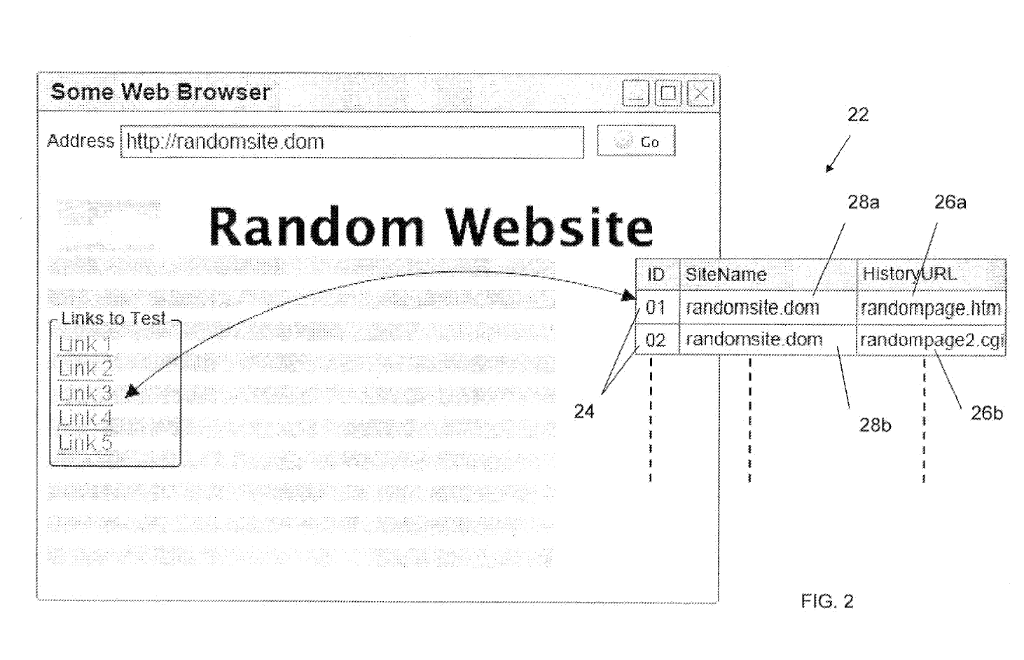

Within all modern browsers the ability to stylise the page using CSS is an inbuilt function. One of the functions of CSS is the ability to style anchor tags/links. As a particular example, and with reference to FIG. 2, whereas hyperlinks 20 are typically presented in blue text, once that link has been followed by a web browser it is subsequently presented (styled) in a different colour, such as purple. Accordingly, this property can be used to determine whether a particular link 20a has been visited or not by the web browser instance.

This is achieved by initially compiling a database 22 of links of interest 24. Then, by querying those links of interest 24 and recording the style of the link 20a, it can be determined whether that link 20a has previously been visited.

Specifically, the technique involves executing the profiling code to display the link of interest 24 within the Document Object Model (“DOM”) of a page and to determine, via a report from the DOM, the colour of the link.

The links of interest 24 might be specific URLs 26, 28. By way of example, if the website operator was interested in finding out whether a visitor to the website has previously visited that website, or a particular page of that website, then the URL 28a of the website and the URLs 26a of specific pages within can be included in the query database 22.

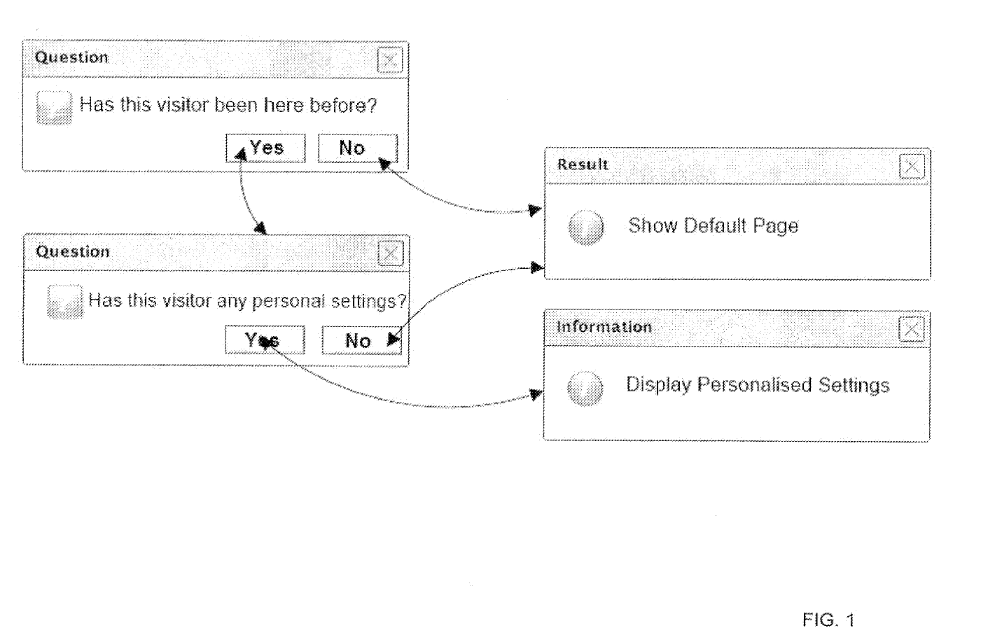

This might provide similar functionality to cookies, in that if it is known that the web browser instance has visited on a prior occasion then the website might be presented in a different manner than if it was a first visit (see FIG. 1).

Beyond that, by including URLs 26b, 28b associated with other websites in the database 22, the operator of the website is able to determine whether a visitor has also visited those other websites. Moreover, if it is determined that another website has been visited, by more targeted queries it can then be determined whether, for example, a transaction has taken place. One way in which this could be determined is by including the URL 26b of the shopping cart page of that other site 28b in the database 22 and querying that URL 26b if it is first determined that the website has been visited. That is not information that could be accessed via a cookie because of the SOP.

Furthermore, it could be instructive to find out that a particular website has not been visited, or a particular link has not been followed.

It can be seen that by compiling a large database 22 of appropriate queries, and structuring the querying so as to ‘funnel’ towards more specific information, a profile of the web browser instance and ergo the user's propensity to undertake certain actions can be identified.

This information might be used to enhance the experience for the user. As mentioned above, the functionality of a cookie might be replicated in order to present a particular page in a particular manner or to redirect to another page depending on the web browser instance's prior activities. This is illustrated, in vastly simplified form, in FIG. 1. From a more direct marketing point of view, a visitor might be offered incentives dependant on their propensity to undertake an action and/or set of actions, as determined by the invention. By way of example only, an online supermarket retailer may offer pet food discount vouchers to a visitor to their website if it the tests carried out on the browser instance are indicative of that website visitor being a pet owner.

### Cache Technique:

By default, all current and modern web browsers cache content that has been previously requested for a defined period of time. The aim for this is to deliver a speedier experience for the web browser user the next time they visit the site by not having to download content such as images, flash files, movies, etc. but instead loading them from the cache.

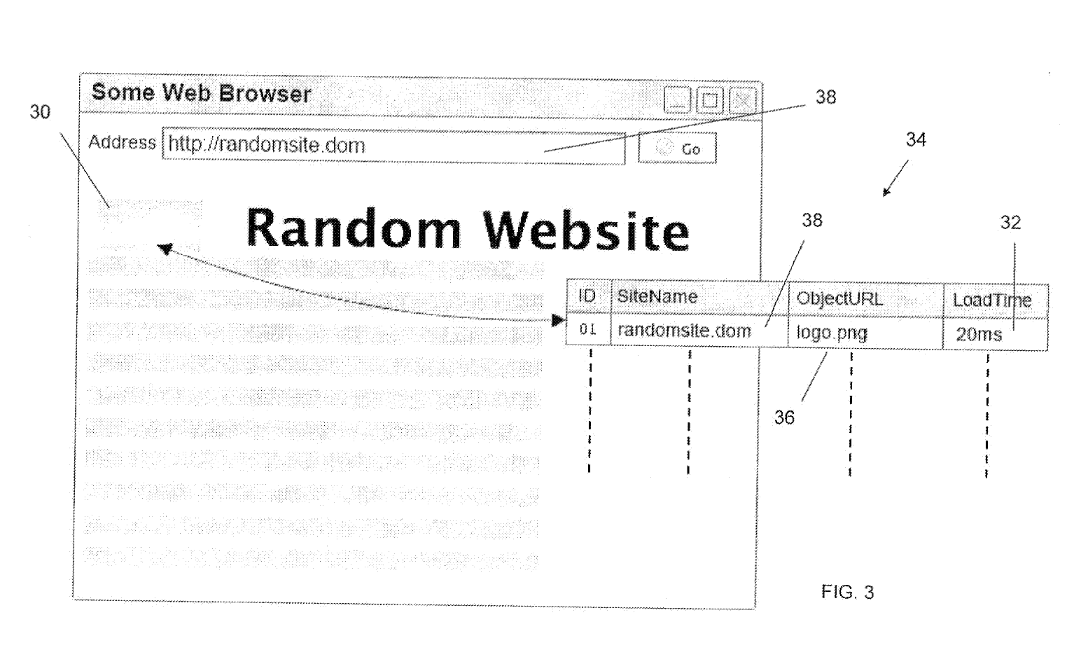

It is possible to inspect the web browser instance's cache indirectly by secondary indications. In particular, and with reference to FIG. 3, it can be determined how long it takes for a particular content item 30, such as an image, to load. Depending on whether the load time 32 is below or above a predetermined threshold, it can be determined whether the item has been loaded from the cache or not.

Specifically, various attributes of that image 30 (or other content item to be tested for) are recorded, including but not limited to image height and/or width and/or size and/or the hash identifier of the image (collectively and singularly “Image Tests”). Then, the profiling code is executed in order to ask the browser to undertake the following process:

Start timer

Start download of the image 30

Once image 30 has either downloaded (if near to immediate) or, if download has not completed in a nearly immediate timeline, image download is stopped.

Stop timer.

The time difference 32 between the start and stop of the timer will show whether the image is cached (near instantaneous download) or not. If the time difference is near instantaneous then this may suggest that the image 30 is cached. The Image Tests are then carried out on the particular image 30 to re-affirm that the image found is the correct one.

Thus, by compiling a database 34 of content items 36 of potential interest, querying those items 36 in turn and measuring download times 32; it can be determined whether those items have been loaded from cache. If so, that would be indicative of the actions undertaken by the web browser instance during the cache period and therefore would be indicative of the user's propensity to undertake certain actions.

The compilation of the items of potential interest 36 into a database 34 includes by way of example only, but not limited to viewing websites of interest 38 and selecting content items 36 that might be indicative of a propensity to undertake certain actions or sets of actions on that website. An example might be an image that is only displayed once a user has logged on to a website 38. If the query shows this image to be cached and it passes the Image Tests, it is a reasonable assumption that the user of the web browser instance has logged in to that particular website 38 and is therefore a member or a user of that web based application.

Further content item examples that might be included in the query database 34 as being indicative of the user's propensity to undertake certain actions, might include a shopping checkout icon.

### Local File Technique:

The protocol that the World Wide Web and therefore all web browsers operate under is known as hyper text transport protocol (http). Within IE, a further protocol to extract resources and known as “resource” is available. This is designed so that images or other resources can be extracted from within binary files on the computer's hard drive system and included within the browser. An example of this functionality is shown by the inclusion of images on the default pages within IE.

see: res://ieframe.dll/noConnect.png

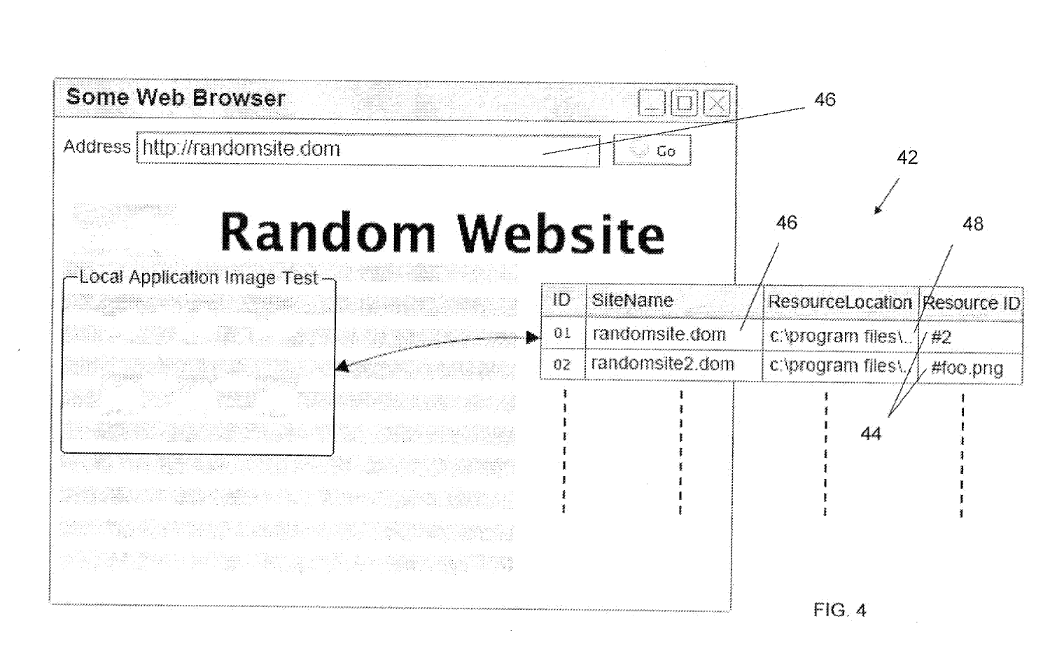

With reference to FIG. 4, this function can be exploited to determine whether particular images 40 or other content items can be included within the web browser instance. This is achieved by initially compiling a database 42 of specific images or other resources of interest 44, such as might be indicative of an application having been installed locally. Then, the profiling code is executed to query the res:// protocol to determine whether a particular item of interest 44, such as an image element associated with such a locally installed application, is present.

Specifically, the image element of interest 44 is included on the web page 46 that the web browser instance is rendering according to the location 48 of a resource within a binary file on the local user's computer based on the specifications and details contained within the protocol. If the image 44 is available to be displayed within the web browser, then it is indicative of the application having been installed locally.

As with the CSS technique, the determination of whether a particular locally installed application is present, could be indicative of a propensity to undertake an action and/or set of actions, as determined by the invention.

Although at present this local install test only works on IE browsers, it is envisaged that similar functionality might in due time be included in other browsers, as new browsers are released and/or existing browsers are up-dated.

Note that for each of the techniques, it is not the entire web browser instance history, cache or res:// local file storage that is determined (to do so would require the respective query databases 22, 34, 42 to cover all URLs 26, 28, 38 and all possible content files 36, 44), but only targeted areas of potential interest. Note also that the contents of the respective databases 22, 34, 42 might be referenced for more than one of the techniques. For example, the images of interest 36, 44 can be queried using both the cache technique and the local file technique. Moreover, a single database might contain all of the respective links and content items of interest.

However, the queries need not be stored in a database and could in the alternative be made in real time with no query being written into a database.

These three techniques can be used singularly or used in any combination to interrogate the web browser instance. For example:

CSS—Has a specific URL 26, 28 previously been visited by the web browser instance?

Cache—Does a specific piece of content 36 exist within the web browser instance's cache?

Local File—Has the user of the web browser installed Software X?

By asking groups of questions from the almost infinite combination of possible URL, locally installed software and website components, it is possible to ask subsequent questions that can funnel, via the dynamic allocation of grouped question sorting, the web browser instance into a unique identification. For example, a line of enquiry might be followed to show a propensity to undertake a particular action, such as undertaking online transactions. So, a first group of queries might relate determining whether the user is a visitor of internet shopping sites. If the results are indicative of the user having visited particular sites, then a second group of queries might relate to determining whether the user is typically just ‘window shopping’ or if they go on to purchase. If the results are indicative of purchases, then a third group of queries might be directed to ascertaining what sorts of products or services have been bought and so on and so forth.

This dynamic allocation of grouped queries approach saves on resources. It would not be worthwhile asking the second or third groups of queries if the first group of queries had shown no propensity of the user to visiting shopping sites.

### Example

It should be noted that this test is artificially small and used as an example only.

Imagine three visitors to a website (hereinafter referred to as “OurSite”) having the functionality of the present invention. While those visitors are on OurSite three factors are tested for, using three differing techniques.

Alice:

Test A: Uses XYZ application that is locally installed

Test B: Is a member of website http://QWE

Test C: Has previously undertaken a transaction at http://bnm

Bob:

Test D: Uses ZXC application that is locally installed

Test B: Is a member of website http://QWE

Test C: Has previously undertaken a transaction at http://bnm

Charlie:

Test A: Uses XYZ application that is locally installed

Test B: Is a member of website http://QWE

Test E: Has previously undertaken a transaction at http://zxc

It is now known that Alice shows positive for Tests ABC, Bob is positive for tests BCD and Charlie is positive for tests ABE.

The web browser is then redirected through combinations of redirects that differ for Alice, Bob and Charlie.

Alice is redirected to http://OURSITE/Identifier//A

then redirected again to http://OURSITE/Identifier/A/B

then again to http://OURSITE/Identifier/A/B/C

Bob is redirected to http://OURSITE/Identifier/B

then redirected again to http://OURSITE/B/C

then again to http://OURSITE/Identifier/B/C/D

Charlie is redirected to http://OURSITE/Identifier/A

then redirected again to http://OURSITE/Identifier/A/B

then again to http://OURSITE/Identifier/A/B/E

At a point in the future a visitor comes to OurSite and it is desirable to know if they have previously visited OurSite and who they are.

A first test is run to determine whether the visitor has been to OurSite before (using the CSS technique on the site's own URL).

If they have not visited OurSite previously, then they are analysed as per Alice, Bob and Charlie for future identification.

If they have been to OurSite before:

A test is run to determine if they have been to http://OURSITE/A or http://OURSITE/B—The result is positive for http://OURSITE/A which means it must be either Alice or Charlie.

Another test is then run to determine if they have been to either http://OURSITE/A/B/C or http://OURSITE/A/B/E as these are the only 2 prior visitors that have previously been identified in the http://OURSITE/A/B group.

The test proves positive for http://OURSITE/A/B/E which indicates that the visitor is (uniquely) Charlie.

Having described the invention, the following is claimed:

1. A method of profiling a web browser instance associated with a computer, comprising the steps of:
storing a web page on a web server, said web page including profiling code;
uploading the web page to a visitor web browser instance responsive to a request from said web browser; and
executing the profiling code on the web server to extract profiling data from the visitor web browser instance;
wherein executing the profiling code includes initiating a series of queries of the visitor web browser instance, the queries including at least one of:
determining whether a specific URL has previously been accessed by the web browser instance;
determining whether a specific piece of content exists within the cache of the web browser instance; and
determining whether a user of the visitor web browser has installed a specific software application on said computer.

2. The method of claim 1, wherein said series of queries includes a combination of two or more of:
determining whether a specific URL has previously been accessed by the web browser instance;
determining whether a specific piece of content exists within the cache of the web browser instance; and
determining whether a user of the visitor web browser has installed a specific software application on said computer.

3. The method of claim 1, wherein each query has either a valid or an invalid response.

4. The method of claim 1, wherein each query is stored in a database.

5. The method of claim 4, wherein the queries are grouped.

6. The method of claim 5, further comprising a step of identifying the IP address of the visitor web browser instance, wherein said series of queries is determined dependent on the IP address.

7. The method of claim 5, wherein said series of queries is determined by dynamic allocation of said grouped queries, a group of queries being asked dependent on the answers to preceding queries.

8. The method of claim 1, wherein determining whether a specific URL has previously been accessed comprises, where the web browser instance utilises cascading style sheets, determining whether the style associated with that URL in the web browser is indicative of previous access.

9. The method of claim 1, wherein determining whether a specific piece of content exists within the cache of the web browser instance comprises determining whether the load speed of said piece of content is below a predetermined threshold indicative of said piece of content being stored in the cache.

10. The method of claim 1, wherein determining whether a user of the visitor web browser has installed a specific piece of software on said computer comprises, utilising the resource:// protocol to extract resources from said computer indicative of said specific piece of software being installed thereon.

11. The method of claim 1, further comprising a step of building a profile of the web browser instance on the basis of the combination of answers to the series of queries.

12. The method of claim 11, wherein said combination of answers builds to a profile that is a unique identifier of a user profile under which the web browser operates.

13. The method of claim 11, wherein the profile includes the propensity of the user of the web browser instance to carry out a specified action and/or set of actions.

14. The method of claim 4, further comprising the steps of:
compiling a list of specific URLs;
compiling a list of specific pieces of content;
compiling a list of specific software applications; and
creating said database of queries on the basis of said compiled lists.

15. A computer program product comprising profiling code uploadable to a web server and/or web browser and executable on the web server and/or web browser to extract profiling data from a visitor web browser instance, wherein said profiling code includes means to initiate a series of queries of the visitor web browser instance, the queries including at least one of:
determining whether a specific URL has previously been accessed by the web browser instance;
determining whether a specific piece of content exists within the cache of the web browser instance; and
determining whether a user of the visitor web browser has installed a specific piece of software on said computer.

16. A web server having computer instructions for executing the steps of:
storing a web page on a web server, said web page including profiling code;
uploading the web page to a visitor web browser instance responsive to a request from said web browser; and
executing the profiling code on the web server and/or web browser to extract profiling data from the visitor web browser instance;
wherein said executing the profiling code includes initiating a series of queries of the visitor web browser instance to uniquely identify a user profile under which the web browser operates.
